(19) United States
(12) Patent Application Publication
(10) Pub. No.: US 2020/0233060 A1
(43) Pub. Date: Jul. 23, 2020

(54) SENSOR DATA ANOMALY DETECTION SYSTEM AND METHOD FOR A VEHICLE

(71) Applicant: Denso International America, Inc., Southfield, MI (US)

(72) Inventors: Joseph C. Lull, South Haven, MI (US); Rajesh Malhan, Troy, MI (US)

(21) Appl. No.: 16/519,583

(22) Filed: Jul. 23, 2019

Related U.S. Application Data
(60) Provisional application No. 62/793,444, filed on Jan. 17, 2019.

(51) Int. Cl. G01S 7/40; G01S 13/93

(52) U.S. Cl. CPC G01S 7/40; G01S 13/931; H04N 17/002; G01S 2013/9367; G01S 2013/9364

(57) ABSTRACT

A sensor data anomaly detection system for a vehicle includes one or more processors and a memory in communication with the one or more processors that stores an anomaly detection module and an anomaly correction module. The anomaly detection module causes the one or more processors to analyze one or more signals from at least one sensor of the vehicle for at least one potential anomaly and compare correlating information from one or more external sources to the at least one potential anomaly to confirm when the potential anomaly is an actual anomaly The anomaly correction module causes the one or more processors to correct the actual anomaly in the one or more signals to generate a corrected signal when the actual anomaly is present.

### CROSS-REFERENCE TO RELATED APPLICATIONS

This application claims the benefit of U.S. Provisional Application No. 62/793,444, entitled “SENSOR DATA ANOMALY DETECTION FOR COOPERATIVE AUTONOMOUS VEHICLE,” filed Jan. 17, 2019, the entirety of which is hereby incorporated by reference.

### TECHNICAL FIELD

The subject matter described herein relates to systems and methods for detecting an anomaly in sensor data, and more particularly to systems and methods for detecting an anomaly in sensor data for a vehicle.

### BACKGROUND

The background description provided is to generally present the context of the disclosure. Work of the inventors, to the extent it may be described in this background section, and aspects of the description that may not otherwise qualify as prior art at the time of filing, are neither expressly nor impliedly admitted as prior art against the present technology.

Computer-controlled devices that rely on information from sensors create challenges to safety and security, especially in the case of autonomous vehicles. Moreover, information from sensors regarding the environment in which the computer-controlled device, such as an autonomous vehicle, can be modified or changed for nefarious reasons. This nefarious modification or changing of information is sometimes referred to as “hacking.” Examples of hacking information from sensors for an autonomous vehicle could include things such as a remotely placed device that intercepts light detection and ranging (“LIDAR”) signals and transmits back an in-phase signal with added data, a radio frequency jamming or scattering device, adding data to radar returns, or by simply adding a paint patch or tape which changes one or more sensors interpretation of a stop sign to a regulated traffic speed sign. Environmental factors may also contribute to sensor data anomalies such as thermal inversions, electromagnetic pulse (“EMP”) or electromagnetic radiation (“EMR”), shadowing, contaminated sensor such as water, dirt or smudge on a camera or LIDAR lens, ice build up on radar, can all produce abnormalities in a sensor signal.

Road users, such as other vehicles, pedestrians, motorcycles, etc., may operate independently in the driving environment and make mobility decisions based on the individual road user's perception of the scenes and objects therein. Even with onboard assessment of the sensor data, this singular assessment of data exposes road users to potential spoofs and other hacks of data resulting in poor decisions which could result in safety issues.

### SUMMARY

This section generally summarizes the disclosure and is not a comprehensive explanation of its full scope or all its features.

In one embodiment, a sensor data anomaly detection system for a vehicle includes one or more processors and a memory in communication with the one or more processors. The memory stores an anomaly detection module and an anomaly correction module. The anomaly detection module when executed by the one or more processors cause the one or more processors to analyze one or more signals from at least one sensor of the vehicle for at least one potential anomaly and compare correlating information from one or more external sources to the at least one potential anomaly to confirm when the potential anomaly is an actual anomaly. The anomaly correction module when executed by the one or more processors cause the one or more processors to correct the actual anomaly in the one or more signals to generate a corrected signal when the actual anomaly is present. A vehicle control system of the vehicle may generate one or more control signals based on the corrected signals.

With regards to anomaly correction, in response to outliers or erroneous data, the algorithm may be trained to omit, or delete the data point or points. Optionally or additionally, an identifying marker can be placed in the dataset to inform a human operator or another algorithm that a datapoint is missing and inform the same to take appropriate action. Thus, the anomaly correction algorithm may be trained to respond to provide treatment of the anomaly or error based on learned responses. A detected object may suddenly disappear then reappear or immediately change character (change from a detected pedestrian to an animal or vehicle for example—this may occur in a deep-fake intrusion or attack), thus the trained algorithm or neural network may recognize an anomalous change in character or signal pattern and continue to report the most confident result as well as a record of the anomalous activity and period resulting in an uninterrupted data flow.

In another embodiment, a method for detecting an anomaly in sensor data for a vehicle includes the steps of analyzing, by one or more processors, one or more signals from at least one sensor mounted to the vehicle for at least one potential anomaly and compare correlating information from an one or more external sources to at least one potential anomaly to confirm when the potential anomaly is an actual anomaly, and correcting, by the one or more processors, the actual anomaly in the one or more signals to generate a corrected signal when the actual anomaly is present. A vehicle control system of the vehicle may generate one or more control signals based on the corrected signal.

In yet another embodiment, a non-transitory computer-readable medium for detecting a sensor data anomaly for a vehicle and including instructions that when executed by one or more processors cause the one or more processors to analyze one or more signals from at least one sensor mounted to the vehicle for at least one potential anomaly and compare correlating information from one or more external sources, which may be a nearby road user with at least one sensor and V2X communication capability, to at least one potential anomaly to confirm when the potential anomaly is an actual anomaly and correct the actual anomaly in the one or more signals to generate a corrected signal when the actual anomaly is present. A vehicle control system of the vehicle may generate one or more control signals based on the corrected signal.

Further areas of applicability and various methods of enhancing the disclosed technology will become apparent from the description provided. The description and specific examples in this summary are intended for illustration only and are not intended to limit the scope of the present disclosure.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates an environment including vehicles and roadside units incorporating systems for detecting anomalies in sensor data;

FIG. 2 illustrates a more detailed view of a vehicle and a roadside unit incorporating the systems for detecting anomalies in sensor data;

FIG. 3 illustrates a chart of three sensor signals, wherein one of the sensor signals includes anomalies;

FIG. 4 illustrates a flow chart of one example of a method for detecting anomalies in sensor data; and

FIG. 5 illustrates a flow chart of another example of a method for detecting anomalies in sensor data.

### DETAILED DESCRIPTION

Disclosed are systems and methods for detecting anomalies in sensor data, which may be in the form of one or more signals, and correcting the anomalies. The systems and methods may utilize correlating information from other road users, such as other vehicles, or from other computing devices, such as cloud-based servers, roadside units, and the like. The systems and methods can compare the collected sensor data with the correlating information to determine if an actual anomaly is present. If an actual anomaly is present, the sensor data can be corrected and then provided to the vehicle control system. As such, the systems and methods described herein allow for the collaborative detection and/or correction of anomalies found in sensor data. The systems and methods may also be trained using known and or labelled datasets such as in machine learning or neural network algorithm.

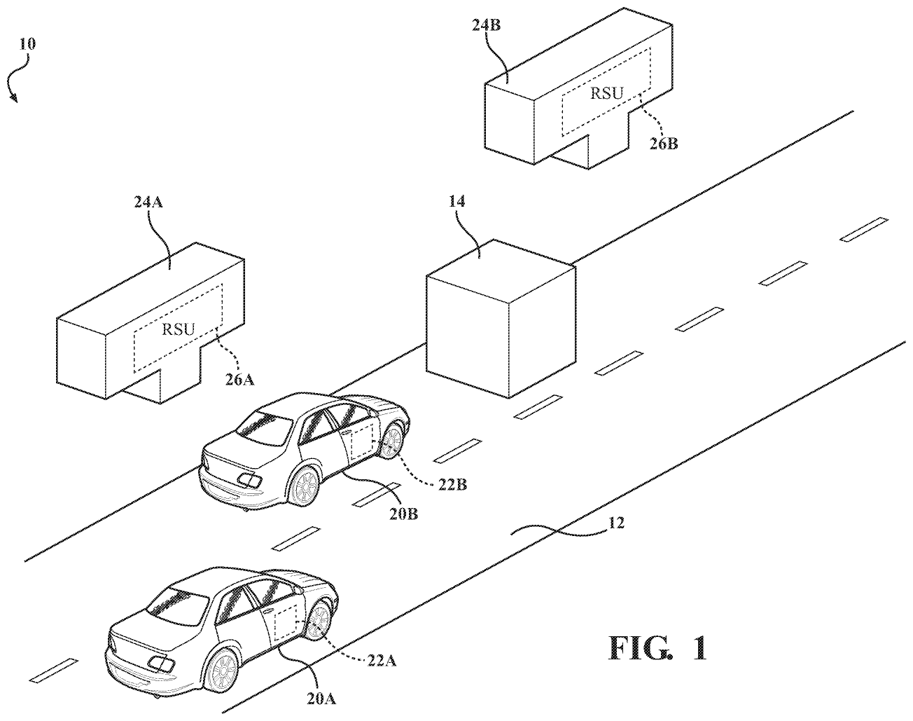

Referring to FIG. 1, a general overview of an environment 10 is shown. Here, the environment 10 includes a roadway 12. The roadway 12, in this example, may contain one or more objects 14. These objects 14 could include fixed objects such as trees and buildings that may be along the side of the roadway but could also include dynamic objects such as animals, pedestrians, debris, lost cargo, and the like.

The example environment 10 also includes vehicles 20A and 20B that generally travel along the surface of the roadway 12. The vehicles 20A and 20B may be equipped with sensor data anomaly detection systems 22A and 22B, respectively. The vehicles 20A and/or 20B may be autonomous vehicles that allow the vehicles 20A and/or 20B to pilot themselves along the roadway 12. It should be understood that the autonomous vehicles 20A and/or 20B may also be able to operate in a semi-autonomous mode, wherein some or even all of the inputs used to control the vehicles 20A and/or 20B are provided by a human driver.

The vehicles 20A and 20B are shown in this example to be automobiles. However, it should be understood that the vehicles 20A and/or 20B may be any type of vehicle capable of transporting persons or items from one location to another. As such, the vehicles 20A and/or 20B may be a truck, heavy-duty truck, tractor-trailer, tractor, mining vehicle, military vehicle, construction vehicle, and the like. Furthermore, while the vehicles 20A and 20B may not be limited to land-based vehicles but could also include other types of vehicles such as aircraft and watercraft. Further, it should be understood while only two vehicles 20A and 20B are shown, the systems and methods disclosed in the specification could apply to any number of vehicles.

The environment 10 also includes roadside units (“RSUs”) 24A and 24B. The RSUs 24A and 24B are computers that can communicate with the vehicles 20A and/or 20B. The RSUs may collect and/or distribute information from the vehicles 20A and/or 20B. The RSUs 24A and 24B may be equipped with sensor data anomaly detection systems 26A and 26B, respectively. The RSUs 24A and 24B are merely representative examples. It should be understood that any one of several different RSUs may be utilized. Further, it should be understood that the RSUs 24A and/or 24B may be cloud-based servers or any other type of electronic device and may not necessarily be located near a roadside.

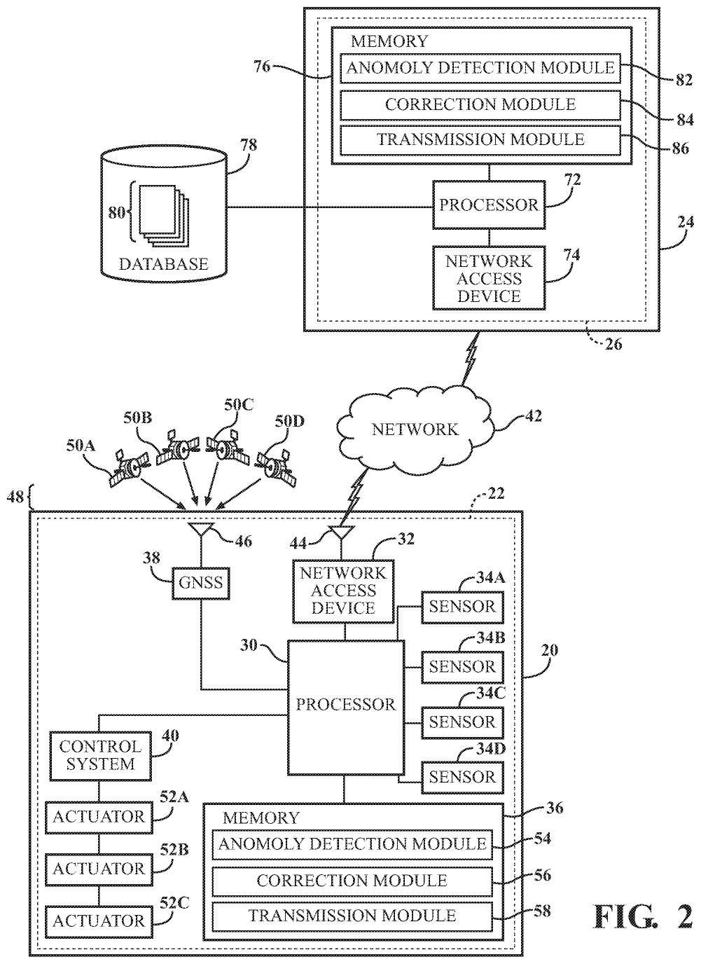

Referring to FIG. 2, a more detailed view of the vehicle 20 and the RSU 24 is shown. As stated before, vehicle 20 includes a sensor data anomaly detection system 22. The sensor data anomaly detection system 22 may include a one or more processors 30. The one or more processors 30 may be in communication with a network access device 32, sensors 34A-34D, a memory device 36, a Global Navigation Satellite System (“GNSS”) 38, and a vehicle control system 40.

With regards to the network access device 32, the network access device 32 may include any one of several different components that allow for the communication of information from the one or more processors 30 to a network 42. The network 42 is generally a distributed network, such as the Internet. Further, the network 42 may be a network of connected vehicles collaborating on a vehicle to vehicle network, which may be a dedicated Short Range Communications (“DSRC”) network. Computing may be distributed via pre-processed data for in certain cases, such as cases involving raw data. The network access device 32 may include one or more antennas 44 that allow for the wireless communication of information between the one or more processors 30 and devices connected to the network 42, such as the RSU 24.

The sensors 34A-34D are sensors that allow the vehicle to sense for objects, such as object 14 in FIG. 1. In this example, sensor 34A may be a camera system, sensor 34B may be a radar system, sensor 34C may be a sonar system, and sensor 34D may be a LIDAR system. The sensors 34A-34D described are merely examples of some the types of sensors that may be utilized. It should be understood that any one of several different sensors and different types of sensors could be utilized and placed in communication with the one or more processors 30.

The GNSS system 38 is a satellite navigation system that provides autonomous geospatial positioning with global coverage. The GNSS system 38 may be any type of GNSS system, such as GPS, GLONASS, Galileo, Beidou and other regional systems. The GNSS system 38 may include one or more antennas 46 that are capable of receiving signals 48 from one or more satellites 50A-50D. Based on the signals 48 from the one or more satellites 50A-50D, the GNSS system 38 can determine the location of the vehicle 20. The location of the vehicle 20 from the GNSS system 38 may be provided in the form of coordinates. These coordinates could include latitude, longitude, and altitude of the vehicle 20.

The vehicle control system 40 may be in communication with actuators 52A-52C. The actuator 52A may be a throttle actuator that controls the forward and/or rearward movement of the vehicle. The actuator 52B may be a braking actuator that applies one or more brakes of the vehicle 20. The actuator 52C may be a steering angle actuator that controls the steering angle of the vehicle 20. It should be understood that the type of actuators and the number of actuators described are merely examples and that any one of several different types or number of actuators may be utilized. The vehicle control system 40, sometimes referred to as a motion controller, generates commands to control the actuators 52A-52C and thus controls the movement of the vehicle 20.

The memory device 36 may be any type of device capable of storing information that can be utilized by the one or more processors 30. As such, the memory device 36 may be a solid-state device, magnetic device, optical device, and the like. The memory device 36, in this example, is located separate from the one or more processors 30. However, it should be understood that the memory device 36 may be incorporated within the one or more processors 30. Additionally, it should be understood that the memory device 36 may be made up of several memory devices, and not a single memory device as shown.

The memory device 36 may store an anomaly detection module 54, a correction module 56, and a transmission module 58. The anomaly detection module 54 when executed by the one or more processors 30 causes the one or more processors 30 to analyze signals from one or more of the sensors 34A-34D for a potential anomaly.

Anomaly detection performed by the one or more processors broadly refers to the task of finding exceptions in the sensor signals that do not conform to the normal and expected behavior of the sensor signals. Any suspected or detected anomaly in the signals from one or more of the sensors 34A-34D may be compared to correlating information from an external source. The correlating information from the external source may be from another vehicle, such as vehicles 20A and/or 20B of FIG. 1 or an RSU, such as RSUs 24A and/or 24B also of FIG. 1.

For example, referring back to FIG. 1, assume that the vehicle 20B is traveling ahead of vehicle 20A on the roadway 12, wherein both vehicles 20A and 20B are travelling in the same direction. In this example, the one or more sensors of the vehicle 20B will detect the object 14. Shortly thereafter, the one or more sensors of vehicle 20A will also detect the object 14. As such, the signals generated by the one or more sensors of the vehicle 20A and 20B may be somewhat similar as they approach the object 14.

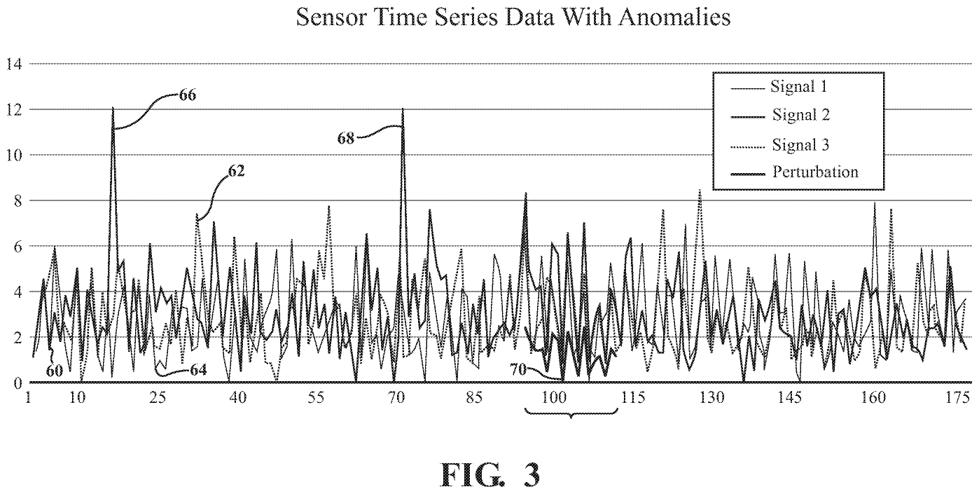

Referring to FIG. 3, three sensor signals 60, 62, and 64 are shown. Sensor signal 60 is a sensor signal collected directly from one or more sensors of a vehicle. Sensor signal 62 and 64 are correlating sensor signals collected and provided from other vehicles or RSUs. Sensor signal 60 contains spikes 66 and 68. The spikes do not appear in sensor signals 62 or 64. As such, the anomaly detection module 54 may determine that the spikes 66 and 68 are anomalies based on the comparison of the correlating sensor signals 62 and 64.

Similarly, a perturbation or embedded signal 70 is shown that has been embedded into signal 60. The anomaly detection module 54 may determine that the embedded signal 70 is an anomaly and should not be part of the signal 60 based on a comparison to signals 62 and 64, which do not include the embedded signal 70. Once this analysis is complete, the anomaly detection module 54 may then confirm that the potential anomalies 66, 68, and 70 are actual anomalies.

The memory device 36 also includes a correction module 56. The correction module 56, when executed by the one or more processors 30, cause the one or more processors to correct the actual anomaly in the one or more signals to generate a corrected signal. As such, referring back to FIG. 3, the correction module 56 may remove the spikes 66 and 68 and the embedded signal 70 from the sensor signals 60. This removal and correction of the signal 60 is essentially a form of cleaning or correcting the data from the sensors to prevent anomalies from being utilized by any other vehicle systems or subsystems. For example, the control system 40 will be provided with a corrected signal to not utilize signals that contain anomalies that may cause an inappropriate movement of the vehicle 20. This inappropriate movement of the vehicle could result in a safety issue to the occupants of the vehicle 20 or others near the vehicle 20.

With regards to anomaly correction, the correction module 56 in response to outliers or erroneous data, the algorithm may be trained to omit, or delete the data point or points. Optionally or additionally, an identifying marker can be placed in the dataset to inform a human operator or another algorithm that a datapoint is missing and inform the same to take appropriate action. Thus, the anomaly correction algorithm may be trained to respond to provide treatment of the anomaly or error based on learned responses. A detected object may suddenly disappear then reappear or immediately change character (change from a detected pedestrian to an animal or vehicle for example—this may occur in a deep-fake intrusion or attack), thus the trained algorithm or neural network may recognize an anomalous change in character or signal pattern and continue to report the most confident result as well as a record of the anomalous activity and period resulting in an uninterrupted data flow

The transmission module 58 may configure the one or more processors 30 to transmit and/or receive information from other systems, such as other vehicles or RSUs. In one example, the transmission module 58 configures the one or more processors 30 two transmit sensor signals generated by the sensors 34A-34D to other vehicles. The other vehicles may utilize the sensor signals from the vehicle 20 as correlating information to be able to detect the presence of actual anomalies and potentially correct actual anomalies within sensor signals. Additionally or alternatively, the transmission module 58 may configure the one or more processors 30 to transmit the presence of the anomaly to warn other systems that anomaly has been detected.

Furthermore, the transmission module 58 may be able to utilize the processing power of one or more RSUs and/or other vehicles to have the RSUs and/or other vehicles to detect the presence of an anomaly and/or correct the anomaly within the signals in a cooperative and parallel fashion. For example, the transmission module 58 may configure the one or more processors 30 to transmit sensor signals from the sensors 34A-34D to the RSU 24 and/or other vehicles. The RSU 24 and/or other vehicles may cooperatively, with or without the vehicle 20, performing anomaly detection and/or correction as described in the paragraphs above. The corrected signal may then be sent back to the one or more processors 30 of the vehicle 20, wherein the one or more processors will utilize the corrected signal.

With regards to the RSU 24, the RSU 24 may include a sensor data anomaly detection system 26. Here, the sensor data anomaly detection system 26 may include one or more processors 72 that are in communication with a network access device 74, and memory device 76 and a database 78. The network access device 74 may include one or more devices that allow for the communication of the one or more processors 72 with the network 42. As stated before, the network 42 may be a distributed network, such as the Internet.

The memory device 76 may be any type of memory device capable of storing information that may be utilized by the one or more processors 72. As such, the memory device may be a solid-state memory device, a magnetic memory device, and/or an optical memory device. Further, it should be understood that the memory device 76 may be incorporated within the one or more processors 72. The memory device 76 may be multiple memory devices.

The memory device 76 stores and anomaly detection module 82, data correction module 84, and a transmission module 86. As will be described later, the anomaly detection module 82, data correction module 84, and the transmission module 86 may be somewhat similar to the anomaly detection module 54, correction module 56, and transmission module 58 of the vehicle 20, respectively. One difference is that the processor 72 of the RSU 24 executes the anomaly detection module 82, data correction module 84, and the transmission module 86.

The database 78 may contain correlating information 80. The database 78 may be a relational type database, wherein data stored within the database 78 may have predefined relationships. The database 78 may be stored in any type of storage device that is capable of providing information to the processor 72. As such, the database 78 may be separate from the RSU 24 is shown or could be integrated within the RSU 24. Further, it should be understood that the database 78 may be spread across multiple storage devices.

The correlating information 80 stored within the database may be a collection of signals generated by the sensors of one or more vehicles. The database 78 essentially collects and organizes the signals, such that they can be quickly accessed and utilized when needed. For example, referring to FIG. 3, the correlating information 80 may include the signals 62 and 64, which, as previously mentioned, were utilized to determine the presence of the anomaly 66, 68, and 70 in the signal 60. The database 78 may be routinely collecting, updating, and/or discarding correlating information 80 as needed. The correlating information 80 may be utilized by the one or more processors 72 of the RSU 24 and/or the one or more processors 30 of the vehicle 20 to determine the presence of one or more anomalies and/or correct the one or more anomalies.

For example, the processor 72, via the network access device 74, can receive the signals from the sensors 34A-34D of the vehicle 20 via the network 42. In addition to receiving signals from the sensors 34A-34D of the vehicle 20, the processor 72 may also receive similar signals from other vehicles. The anomaly detection module 82 configures the one or more processors 72 to analyze the signals received from the vehicle 20 to detect any potential anomalies. The signal from the sensors 34A-34D of the vehicle 20 can be compared with signals received from other vehicles. These signals received from other vehicles are the correlating information which may be stored as correlating information 80 on the database 78.

As explained previously, and as best shown in FIG. 3, the one or more processors 72 of the RSU 24 may compare signals from different vehicles and/or correlating information 80. Based on the comparison, the processor 72 can determine if an anomaly, either potential or actual, is detected. In this example, the signal 60 has been determined to have anomalies 66, 68, and 70 based on the comparison to signals 62 and 64.

The correction module 84 configures the one or more processors 72 to correct any detected anomalies found in the signals from the sensors 34A-34D of the vehicle 20. This correction may replace any detected anomalies found in the signal with a clean signal that has removed the anomalies and replaced the anomalies with a signal that does not contain the anomaly which may have come from another vehicle and/or the correlating information 80 stored in the database 78.

The transmission module 86 may configure the one or more processors 72 to transmit this corrected signal back to the vehicle 20 via the network access device 74. The control system 40 of the vehicle 20 may then utilize the corrected signal to appropriately actuate the actuators 52A-52C of the vehicle 20. Additionally or alternatively, the transmission module 86 may configure the one or more processors 72 transmit via the network access device 74 the presence of the actual anomaly to another vehicle or an external source, such as another RSU or electronic device.

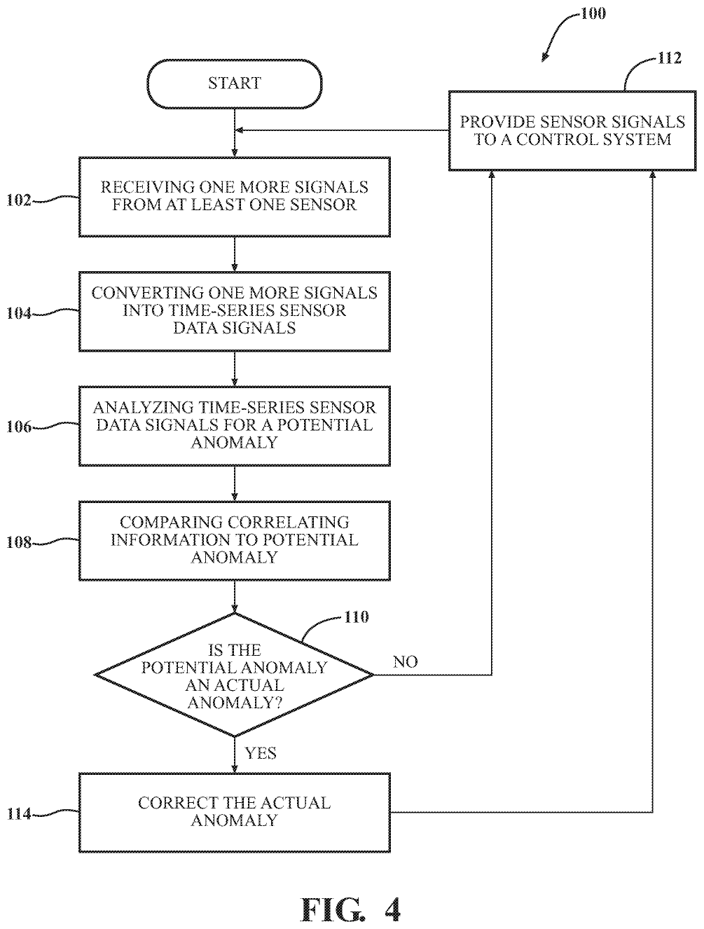

Referring to FIG. 4, a method 100 for detecting an anomaly in sensor data for the vehicle, such as vehicle 20 of FIG. 2 is shown. In one example, the method 100 may be performed by either the one or more processors 30 of the vehicle 20 and/or one or more processors 72 of the RSU 24. The method 100 begins at step 102, wherein one or more signals from at least one sensor are received. In this example, the one or more signals could be generated by sensors 34A-34D of the vehicle 20 and then received by either the one or more processors 30 of the vehicle 20 or the one or more processors 72 of the RSU 24.

In step 104, the one or more signals from the sensors are converted into time series sensor data signals. The signals generated by the sensors 34A-34D may be in the form of raw signals. The conversion to time series sensor data signals essentially converts the raw signals into a sequence of data points that may include successive measurements made by the same source over a time interval. In addition to this conversion, other data enhancements may be performed, such as smoothing, noise reduction, and the like. Furthermore, it should be understood that step 104 is optional and the method 100 may instead utilize raw sensor data signals and not perform any time series conversion.

In step 106, the sensor signals are analyzed for any potential anomalies. As stated before, the sensor signals may be time series sensor signals or may be the raw sensor signals. The analysis of the sensor signals for an anomaly may include any one of several different methodologies utilized to determine the presence of a potential anomaly. For example, these methodologies could include statistical methodologies and/or machine learning based approaches, such as density-based anomaly detection, clustering based anomaly detection, and/or support vector machine-based anomaly detection. The types of anomalies detected could include point-wise anomalies, collective anomalies, or contextual anomalies.

In step 108, the sensor signals are compared to correlating information. Moreover, all or part of the sensor signal may be compared to correlating information, which could include other sensor signals collected from other devices, such as other vehicles or stored in a database, such as a database 78. In this step, the method 100 may determine based on the comparison of all or part of the sensor signal to the correlating information that an actual anomaly is present. A decision regarding if an actual anomaly is present is performed in step 110. In the event no actual anomaly is present, the method proceeds to step 112, wherein the sensor data signals are provided to a control system, such as the vehicle control system 40 of FIG. 2.

However, if an actual anomaly is detected the method 100 proceeds to step 114. In step 114, the anomaly is corrected. The anomaly in the sensor signal may be corrected by either replacing the anomaly in the sensor signal with a normalized signal, which may be derived from the correlating information. Furthermore, other ways of correcting the signals could also be utilized, such as smoothing, data analysis, or simply ignoring the anomaly in the signal. After step 112 has been performed, the corrected sensor signals are then provided to the vehicle control system as shown in step 112. After step 112, the method 100 may simply end or may return to step 102.

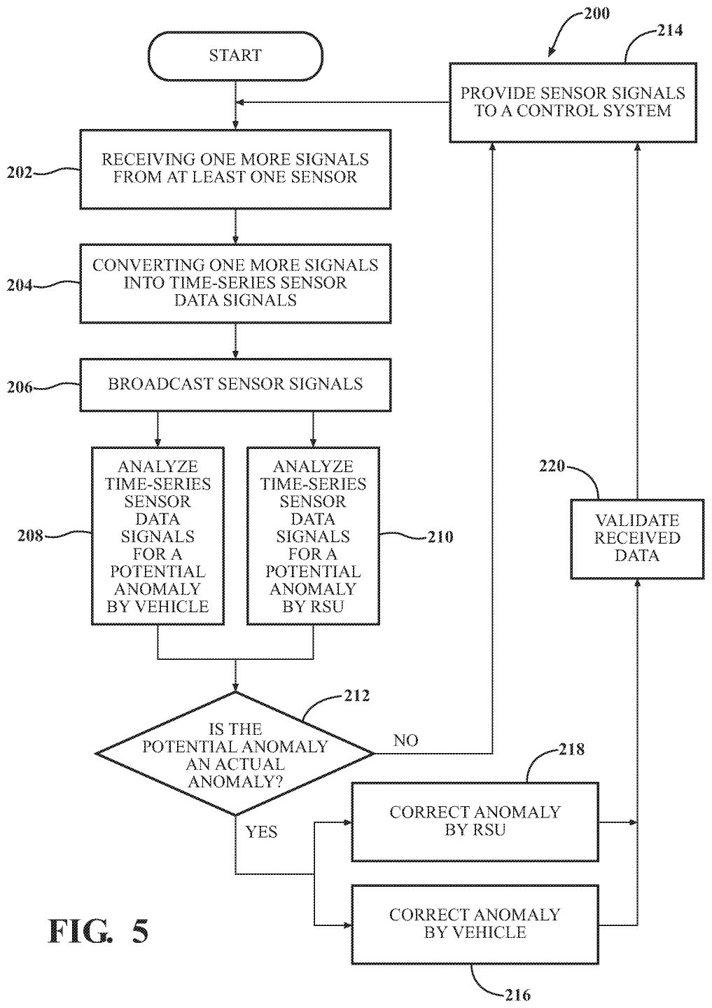

Referring to FIG. 5, another example of a method 200 for detecting an anomaly in a sensor signal is shown. In one example, the method 200 may be performed by the one or more processors 30 of the vehicle 20 and/or the one or more processors 72 of the RSU 24. However, it should be understood that the method 200 may be performed by any one of several different electronic devices. The method 200 takes a collaborative and cooperative approach, where in multiple systems, such as vehicles RSUs and the like, perform analysis and correction of anomalies.

Here, the method 200 begins with step 202, wherein one or more signals from at least one sensor are received. The one or more signals could be one or more sensor signals generated by the sensors 34A-34D of the vehicle 20 and received by the one or more processors 30 of the vehicle 20 and/or the one or more processors 72 of the RSU 24 of FIG. 2.

In step 204, the one or more signals from the sensors are converted into time series sensor data signals. The signals generated by the sensors 34A-34D may be in the form of raw signals. The conversion to time series sensor data signals essentially converts the raw signals into a sequence of data points that may include successive measurements made by the same source over a time interval. In addition to this conversion, other data enhancements may be performed, such as smoothing, noise reduction, and the like. Furthermore, it should be understood that the step 204 is optional and the method 200 may instead utilize raw sensor data signals and not perform any time series conversion.

In step 206, the sensor signals may be broadcast to other devices. Here, sensor signals are broadcast to other devices with the ultimate goal of allowing other devices to collaboratively and cooperatively detect the presence of anomalies and/or correct any detected anomalies. The broadcasting of the sensor signals may be performed by one or more network access devices, such as network access devices 32 and 74 of FIG. 2.

In step 208 and 210, an analysis of the sensors data signals is performed to determine if any potential or actual anomalies are present. In step 208, the analysis of the sensor signals may be performed by one or more vehicles. In step 210, the analysis of the sensor signals is performed by one or more RSUs or other devices connected to the network.

In step 212, a decision is made if a potential or actual anomaly is present. The decision may be made collaboratively by the devices based on the analyses performed in step 208 and 210 or could be determined individually by the vehicles and/or RSUs performing the analyses. As stated before, the sensor signals may be time series sensor signals or may be the raw sensor signals. The analysis of the sensor signals for an anomaly may include any one of several different methodologies utilized to determine the presence of a potential anomaly. For example, these methodologies could include statistical methodologies and/or machine learning based approaches, such as density-based anomaly detection, clustering based anomaly detection, and/or support vector machine-based anomaly detection. The types of anomalies detected could include point-wise anomalies, collective anomalies, or contextual anomalies. If it has been determined that no anomaly is present, the method proceeds to step 214, where sensor data signals are provided to a control system, such as the vehicle control system 40 of FIG. 2.

If an anomaly has been detected, the method 200 proceeds to step 216 and 218. In steps 216 and 218 the vehicles and/or RSUs, respectively, proceeds to correct the anomaly. The anomaly in the sensor signal may be corrected by either replacing the anomaly in the sensor signal with a normalized signal, which may be derived from the correlating information. Furthermore, other ways of correcting the signals could also be utilized, such as smoothing, data analysis, or simply ignoring the anomaly in the signal.

After correction, the corrected signal is then validated, shown in step 220. Moreover, as stated previously, the detection and correction of the anomalies may have been performed by one or more different vehicles and/or RSUs. The purpose of step 220 is so that the receiving vehicle that will may utilize the corrected signals verifies the validity of the corrected signals. From there, the corrected signals are then provided to the control system, shown in step 214.

It should be appreciated that any of the systems described in this specification can be configured in various arrangements with separate integrated circuits and/or chips. The circuits are connected via connection paths to provide for communicating signals between the separate circuits. Of course, while separate integrated circuits are discussed, in various embodiments, the circuits may be integrated into a common integrated circuit board. Additionally, the integrated circuits may be combined into fewer integrated circuits or divided into more integrated circuits.

In another embodiment, the described methods and/or their equivalents may be implemented with computer-executable instructions. Thus, in one embodiment, a non-transitory computer-readable medium is configured with stored computer executable instructions that when executed by a machine (e.g., processor, computer, and so on) cause the machine (and/or associated components) to perform the method.

While for purposes of simplicity of explanation, the illustrated methodologies in the figures are shown and described as a series of blocks, it is to be appreciated that the methodologies are not limited by the order of the blocks, as some blocks can occur in different orders and/or concurrently with other blocks from that shown and described. Moreover, less than all the illustrated blocks may be used to implement an example methodology. Blocks may be combined or separated into multiple components. Furthermore, additional and/or alternative methodologies can employ additional blocks that are not illustrated.

Detailed embodiments are disclosed herein. However, it is to be understood that the disclosed embodiments are intended only as examples. Therefore, specific structural and functional details disclosed herein are not to be interpreted as limiting, but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations.

The flowcharts and block diagrams in the figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product which comprises all the features enabling the implementation of the methods described herein and, which when loaded in a processing system, is able to carry out these methods.

Furthermore, arrangements described herein may take the form of a computer program product embodied in one or more computer-readable media having computer readable program code embodied, e.g., stored, thereon. Any combination of one or more computer-readable media may be utilized. The computer-readable medium may be a computer readable signal medium or a computer-readable storage medium. The phrase “computer-readable storage medium” means a non-transitory storage medium. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Examples of such a computer-readable medium may include, but are not limited to, a floppy disk, a flexible disk, a hard disk, a magnetic tape, other magnetic medium, an ASIC, a graphics processing unit (GPU), a CD, other optical medium, a RAM, a ROM, a memory chip or card, a memory stick, and other media from which a computer, a processor or other electronic device can read. In the context of this document, a computer-readable storage medium may be any tangible medium that can contain or store a program for use by or in connection with an instruction execution system, apparatus, or device.

The following includes definitions of selected terms employed herein. The definitions include various examples and/or forms of components that fall within the scope of a term, and that may be used for various implementations. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Module,” as used herein, includes a computer or electrical hardware component(s), firmware, a non-transitory computer-readable medium that stores instructions, and/or combinations of these components configured to perform a function(s) or an action(s), and/or to cause a function or action from another logic, method, and/or system. Module may include a microprocessor controlled by an algorithm, a discrete logic (e.g., ASIC), an analog circuit, a digital circuit, a programmed logic device, a memory device including instructions that when executed perform an algorithm, and so on. A module, in one or more embodiments, includes one or more CMOS gates, combinations of gates, or other circuit components. Where multiple modules are described, one or more embodiments include incorporating the multiple modules into one physical module component. Similarly, where a single module is described, one or more embodiments distribute the single module between multiple physical components.

Additionally, module, as used herein, includes routines, programs, objects, components, data structures, and so on that perform tasks or implement data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), as a graphics processing unit (GPU), or as another suitable hardware component that is embedded with a defined configuration set (e.g., instructions) for performing the disclosed functions.

In one or more arrangements, one or more of the modules described herein can include artificial or computational intelligence elements, e.g., neural network, fuzzy logic, or other machine learning algorithms. Further, in one or more arrangements, one or more of the modules can be distributed among a plurality of the modules described herein. In one or more arrangements, two or more of the modules described herein can be combined into a single module.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™ Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A sensor data anomaly detection system for a vehicle, the system comprising:
one or more processors;
a memory in communication with the one or more processors and storing:
an anomaly detection module including instructions when executed by the one or more processors cause the one or more processors to analyze one or more signals from at least one sensor of the vehicle for at least one potential anomaly and compare correlating information from one or more external sources to the at least one potential anomaly to confirm when the potential anomaly is an actual anomaly; and
an anomaly correction module including instructions when executed by the one or more processors cause the one or more processors to correct the actual anomaly in the one or more signals to generate a corrected signal when the actual anomaly is present, wherein a vehicle control system of the vehicle generates one or more control signals based on the corrected signal.

2. The sensor data anomaly detection system of claim 1, wherein the anomaly correction module further includes instructions to perform at least one of:
inform one or more vehicle systems that the actual anomaly is present; and
replace the actual anomaly in the one or more signals with data from the correlation information.

3. The sensor data anomaly detection system of claim 1, wherein the memory in communication with the one or more processors stores a transmission module including instructions when executed by the one or more processors cause the one or more processors to perform at least one of:
transmit the presence of the actual anomaly to at least one other vehicle; and
transmit the presence of the actual anomaly to the one or more external sources.

4. The sensor data anomaly detection system of claim 1, wherein the one or more external sources are at least one of a second vehicle, a roadside unit, and a cloud based server.

5. The sensor data anomaly detection system of claim 1, wherein the at least one sensor is at least one of a camera system, a radar system, a sonar system, and a lidar system.

6. The sensor data anomaly detection system of claim 1, wherein the one or more signals are raw sensor data.

7. The sensor data anomaly detection system of claim 1, wherein the one or more signals are time-series sensor data signals.

8. The sensor data anomaly detection system of claim 1, wherein the memory in communication with the one or more processors and stores a transmission module including instructions when executed by the one or more processors cause the one or more processors to broadcast, via a network access device, to the one or more external sources the actual anomaly, wherein the one or more external sources corrects the actual anomaly to generate a corrected signal.

9. The sensor data anomaly detection system of claim 8, wherein the anomaly correction module further includes instructions to receive via the network access device the corrected signal from one or more external sources and replace the actual anomaly in the one or more signals with the corrected signal.

10. A method for detecting an anomaly in sensor data for a vehicle, the method comprising the steps of:
analyzing, by one or more processors, one or more signals from at least one sensor mounted to the vehicle for at least one potential anomaly;
comparing correlating information from one or more external sources to at least one potential anomaly to confirm when the potential anomaly is an actual anomaly; and
correcting, by the one or more processors, the actual anomaly in the one or more signals to generate a corrected signal when the actual anomaly is present, wherein a vehicle control system of the vehicle generates one or more control signals based on the corrected signal.

11. The method of claim 10, further comprising at least one of the steps of:
informing, by the one or more processors, one or more vehicle systems that the actual anomaly is present;
replacing, by the one or more processors, the actual anomaly in the one or more signals with data from the correlation information;
transmitting, by the one or more processors, via a network access device, the presence of the actual anomaly to at least one other vehicle; and
transmitting, by the one or more processors, via the network access device, the presence of the actual anomaly to the one or more external sources.

12. The method of claim 10, wherein the one or more external sources are at least one of a second vehicle, a roadside unit, and a cloud based server.

13. The method of claim 10, wherein the at least one sensor is at least one of a camera system, a radar system, a sonar system, and a lidar system.

14. The method of claim 10, wherein the one or more signals are raw sensor data.

15. The method of claim 10, wherein the one or more signals are time-series sensor data signals.

16. The method of claim 10, further comprising the step of broadcasting, by the one or more processors, via a network access device, to the one or more external sources the actual anomaly, wherein the one or more external sources corrects the actual anomaly to generate the corrected signal.

17. The method of claim 16, further comprising the steps of: receiving, by the one or more processors, via the network access device, the corrected signal from one or more external sources; and
replacing, by the one or more processors, the actual anomaly in the one or more signals with the corrected signal.

18. A non-transitory computer-readable medium for detecting a sensor data anomaly for a vehicle and including instructions that when executed by one or more processors cause the one or more processors to:analyze, by the one or more processors, one or more signals from at least one sensor mounted to the vehicle for at least one potential anomaly and compare correlating information from one or more external sources to at least one potential anomaly to confirm when the potential anomaly is an actual anomaly; and
correct, by the one or more processors, the actual anomaly in the one or more signals to generate a corrected signal when the actual anomaly is present, wherein a vehicle control system of the vehicle generates one or more control signals based on the corrected signal.

19. The non-transitory computer-readable medium of claim 18, further including instructions that when executed by one or more processors of the vehicle cause the one or more processors to:
inform, by the one or more processors, one or more vehicle systems that the actual anomaly is present;
replace, by the one or more processors, the actual anomaly in the one or more signals with data from the correlation information;
transmit, by the one or more processors, via a network access device, the presence of the actual anomaly to at least one other vehicle; and
transmit, by the one or more processors, via the network access device, the presence of the actual anomaly to the one or more external sources.

20. The non-transitory computer-readable medium of claim 18, wherein the one or more signals are time-series sensor data signals.
